(19) United States
(12) Patent Application Publication
(10) Pub. No.: US 2023/0406426 A1
(43) Pub. Date: Dec. 21, 2023

(54) TRACK RUNNING GEAR AND CIVILIAN TRACKED VEHICLE

(71) Applicant: Kässbohrer Geländefahrzeug AG, Laupheim (DE)

(72) Inventors: Alexander FINK, Dornstadt (DE); Stefan HECHT, Tiefenbach (DE); Marius HOLDER, Granheim (DE)

(21) Appl. No.: 18/334,620

(22) Filed: Jun. 14, 2023

(30) Foreign Application Priority Data
Jun. 15, 2022 (DE) 102022206052.0

(51) Int. Cl. B62D 55/06; B62D 55/24; B62D 55/30

(52) U.S. Cl. CPC B62D 55/06; B62D 55/30; B62D 55/24

(57) ABSTRACT

A track running gear for a track chassis of a civilian tracked vehicle, having a rubber continuous track guided circumferentially over an end drive wheel, an opposite tension wheel and over a plurality of running wheels. Each of the running wheels touches a lower strand of the rubber continuous track. At least two of the running wheels touch an upper strand, which upper strand is located opposite the lower strand, of the rubber continuous track.

### CROSS-REFERENCE TO RELATED APPLICATION

This claims priority from German Application No. 10 2022 206 052.0, filed Jun. 15, 2022, the disclosure of which is hereby incorporated by reference in its entirety.

### TECHNICAL FIELD

The invention relates to a track running gear for a track chassis of a civilian tracked vehicle, having a rubber continuous track which is guided circumferentially over an end drive wheel, an opposite tension wheel and over a plurality of running wheels. Each of the running wheels touches a lower strand of the rubber continuous track. The invention further relates to a civilian tracked vehicle having a carrier frame and having a track chassis which has such a track running gear at opposite sides of the carrier frame.

### BACKGROUND AND SUMMARY

Such a civilian tracked vehicle is known from WO 2013/029165 A1. The known civilian tracked vehicle has a carrier frame and a track chassis which has a track chassis of the type mentioned in the introduction at opposite sides of the carrier frame. Each of these track running gears comprises a rubber continuous track which is guided circumferentially over an end drive wheel, an opposite tension wheel and over a plurality of running wheels. In this case, each of the running wheels touches a lower strand of the continuous track in the known track running gear. In the known track running gear, each of the running wheels is arranged with spacing from an upper strand, which is opposite the lower strand of the rubber continuous track, of the continuous track. None of the running wheels touches the upper strand in the known track running gear. A spacing between the tension wheel and drive wheel is adjustable in order to adjust a track tension of the rubber continuous track. In this case, the upper strand is tensioned or suspended between the tension wheel and the drive wheel so as to be able to oscillate. Support of the upper strand between the drive wheel and tension wheel is not provided. Consequently, the upper strand can oscillate freely. If the upper strand is excited to oscillate during operation of the track running gear by drive oscillations and/or unevenness of the ground, this can lead in the worst case to the continuous track losing its lateral guiding. Thus, if an amplitude of the oscillation becomes too great, the rubber continuous track can slip laterally off the drive wheel and/or the tension wheel. This leads to failure of the track running gear. In order to counteract this, in the known track chassis the rubber continuous track must be tensioned in a comparatively powerful manner. However, the rubber continuous track is thereby particularly loaded, which promotes the wear thereof.

One aspect of the invention is to provide a track running gear and a civilian tracked vehicle of the type mentioned in the introduction which have improved properties over the prior art and which in particular are particularly reliable. In particular, an amplitude of an operationally caused oscillation of the upper strand and a track tension are intended to be reduced.

This is achieved for the track running gear in that at least two of the running wheels, in particular at least in a state, located on even underlying ground, of the track running gear touch the upper strand, which is opposite the lower strand, of the rubber continuous track. The term “rubber continuous track” is intended to be understood in this instance to mean a track band which comprises a rubber material and which extends annularly in a manner which cannot be separated without being destroyed. The rubber material may be a natural rubber and/or a synthetic rubber and/or another suitable elastomer material. The rubber continuous track can be interpreted to be a rubber continuous belt, in particular a toothed belt. The rubber continuous track differs from a conventional crawler chain substantially in that the rubber continuous track does not allow any segments or chain links to be seen at least in an outward direction. A chain joint is not provided. Since the upper strand in the track running gear according to the invention is positioned on at least two of the running wheels, no regions or only comparatively short regions of the upper strand are free to oscillate. In comparison with the above-mentioned known track running gear, consequently, in the track running gear according to the invention oscillation amplitudes which are many times smaller are produced. Even with a smaller track tension, consequently, it is possible to prevent the upper strand from beginning to oscillate at such a great amplitude that it can result in a loss of the lateral guiding. Lateral slipping of the rubber continuous track off the drive wheel and/or the tension wheel is consequently combatted even with reduced track tension. The track running gear according to the invention is accordingly found to be particularly reliable.

Advantageously, more than two of the running wheels touch both the upper strand and the lower strand. In a particularly advantageous manner, all of the running wheels touch both the upper strand and the lower strand. The more the running wheels touch both the upper strand and the lower strand, the shorter are the freely oscillating regions of the upper strand. Accordingly, a track tension can be further reduced with an increasing number of running wheels which touch the upper strand and the lower strand.

Advantageously, at least one of the running wheels is arranged with spacing from the upper strand. As a result, the conflict in terms of objectives explained below can be overcome in a particularly cost-efficient manner. This is because it is desirable in terms of production and costs to configure all the running wheels with a uniform size. The larger a running wheel is, the more complex and cost-intensive the production thereof becomes. The smaller a running wheel is, the smaller the tension wheel and/or drive wheel also has to be in order to ensure contact of the at least two running wheels with the upper strand and lower strand. However, the size of the tension wheel and/or running wheel is limited by a permissible minimum bending radius of the rubber continuous track. By one of the running wheels being arranged with spacing from the upper strand, a size of the running wheels can be selected so that the at least two of the running wheels—but certainly not all of the running wheels—retain the contact with the upper strand and lower strand. A particularly good compromise between a drivable track tension, ensuring the lateral guiding and production costs of the running wheels is achieved. The running wheel which is arranged with spacing from the upper strand can preferably be the running wheel which is nearest the drive wheel. Advantageously, consequently, the drive wheel can be arranged with a particularly large spacing from the underlying ground if all the running wheels are configured with a uniform size. This reduces any risk that the drive wheel might come into contact with the underlying ground when travelling over uneven terrain.

Preferably, the rubber continuous track has an inner toothing which extends at the internal circumference and an outer toothing which extends at the external circumference and which meshes with the inner toothing in order to drive the rubber continuous track in a positive-locking manner. It is consequently possible to transmit drive forces particularly efficiently to the rubber continuous track and to the underlying ground by means of the rubber continuous track.

Advantageously, the inner toothing and the outer toothing are adapted to each other geometrically. The inner toothing and the outer toothing may have the same modulus. A tooth height of the outer toothing may be identical to a tooth height of the inner toothing. The tooth heights of the outer toothing and inner toothing can be of different sizes. The tooth height of the outer toothing can be less than or greater than the tooth height of the inner toothing. A corresponding geometric adaptation allows a particularly quiet and low-wear running of the rubber continuous track.

Advantageously, the rubber continuous track has an annular base member which is constructed so as to extend continuously in a circumferential direction. The term “extending continuously” is intended to be understood in this case to mean that the base member is free from front ends which have to be connected to each other in the circumferential direction in order to close the annular shape. The base member is constructed to be free from any chain joint. The annular shape of the base member cannot be separated transversely to the circumferential direction without being destroyed. Such a rubber continuous track is found to be particularly low in terms of maintenance.

Advantageously, the inner toothing is constructed at an internal circumference of the base member. Consequently, the base member can be wrapped around the drive wheel in order to bring a particularly large number of teeth of the outer toothing into engagement with the inner toothing.

Advantageously, the inner toothing has a large number of intermediate tooth spaces which are arranged equidistantly to each other in the circumferential direction and which step back from the internal circumference. A particularly flat profile of the rubber continuous track is produced.

In another embodiment, at least one of the running wheels has an external annular profiling which is provided to laterally guide the rubber continuous track in a positive-locking manner. The annular profiling can extend at an external circumference of the relevant running wheel. This aids in combatting lateral slipping of the rubber continuous track down from the running wheels.

In another embodiment, the inner toothing of the rubber continuous track has a large number of track brackets which are arranged with spacing from each other in the circumferential direction and which externally flank the tension wheel and the drive wheel and which engage in an annular groove, which acts as an annular profiling, of the running wheels for laterally guiding the rubber continuous track. The track brackets which engage in the annular groove and which axially flank at both sides the tension wheel and drive wheel provide a structurally particularly simple-to-implement way of laterally guiding the rubber continuous track in a positive-locking manner.

In another embodiment, a tooth of the inner toothing is constructed in the circumferential direction between two adjacent intermediate tooth spaces of the inner toothing, which tooth is flanked by webs of a track bracket, respectively. A longitudinal direction and a vertical direction can define a vertical plane. The vertical direction can extend in the circumferential direction. The webs which are present in pairs on one of the teeth can be arranged with spacing from each other transversely relative to the circumferential direction, in particular transversely relative to the vertical plane. The respective tooth can be arranged transversely relative to the circumferential direction, in particular transversely relative to the vertical plane, between the pair of webs which is present thereon. Such a continuous track has a particularly compact construction, in particular transversely relative to the vertical plane.

In another embodiment, the intermediate tooth spaces completely extend through the base member in the vertical direction. In particular, the intermediate tooth spaces extend through the base member along the vertical plane. The base member can be radially completely passed through by the intermediate tooth spaces. Foreign substances, such as dirt, which reach the intermediate tooth spaces from the internal circumference can consequently be discharged directly outward and vice versa.

In another embodiment, the base member comprises an elastomer matrix, in particular made from a rubber material. The rubber material can comprise at least one rubber admixture. The rubber material may comprise different rubber admixtures. Different rubber admixtures can be provided in different regions of the base member, in particular transversely relative to the vertical plane. The rubber material can comprise at least one rubber selected from natural and/or synthetic rubber and/or another suitable elastomer material. Such a base member is particularly resistant to contact with aggressive media and further allows a particularly reliable frictional contact between the lower strand and the underlying ground.

In another embodiment, in order to transmit drive forces, the base member comprises a reinforcement device which is embedded in the elastomer matrix, in particular completely. This counteracts failure of the rubber continuous track, in particular tearing transversely relative to the circumferential direction.

The reinforcement device advantageously comprises a large number of steel cords. The steel cords can extend along and/or at an angle relative to the circumferential direction. Alternatively or additionally, the reinforcement device may comprise a planar fiber inlay with reinforcement fibers. The reinforcement fibers may comprise inorganic and/or organic fibers. The reinforcement fibers can be selected from the group comprising glass fibers (that is to say, fibers having or comprising glass), basalt fibers (that is to say, fibers having or comprising basalt), boron fibers (that is to say, fibers having or comprising boron), ceramic fibers (that is to say, fibers having or comprising ceramic material), silicic acid fibers (that is to say, fibers having or comprising silicic acid), steel fibers (that is to say, fibers having or comprising steel), polyamide fibers (that is to say, fibers having or comprising polyamide), aramide fibers (that is to say, fibers having or comprising aramide), carbon fibers (that is to say, fibers having or comprising carbon), black diamond fibers (that is to say, fibers having or comprising black diamond), nylon fibers (that is to say, fibers having or comprising nylon), polyethylene fibers (that is to say, fibers having or comprising polyethylene), plexiglass fibers (that is to say, fibers having or comprising plexiglass) and admixtures of at least two of the above-mentioned fibers. The planar fiber inlay may be a textile. In particular, the planar fiber inlay may be a web, a woven fabric, a hosiery fabric, a knitted fabric or a nonwoven fabric, or a combination of at least two of the above-mentioned textiles. A particularly resistant rubber continuous track is produced.

In another embodiment, the reinforcement device comprises a large number of core members, in particular made of steel, which each extend transversely relative to the circumferential direction. In particular, the core members extend transversely relative to the vertical plane. The core members advantageously rigidify the base member transversely relative to the circumferential direction, in particular transversely relative to the vertical plane.

Consequently, a drive force can advantageously be transmitted over the entire width of the rubber continuous track to the underlying ground.

In another embodiment, the core members are arranged equidistantly to each other in the circumferential direction in an alternating manner with the intermediate tooth spaces of the inner toothing. The core members are therefore present in the region of the teeth of the inner toothing. Consequently, they support the force transmission from the outer toothing to the inner toothing.

In another embodiment, at least one double axle arrangement is present and comprises an axle carrier and a running wheel pair with two of the running wheels, wherein the axle carrier has a suspension device for connecting the double axle arrangement to a carrier frame of the tracked vehicle in a rotationally movable, in particular floating and/or oscillating manner, and wherein the two running wheels of the running wheel pair are supported in a rotationally movable manner on the axle carrier with radial spacing from each other. Consequently, unevenness of the underlying ground travelled over can be at least partially compensated for by a pivot movement of the axle carrier relative to the carrier frame.

In another embodiment, the axle carrier extends in the longitudinal direction between a first carrier end and a second carrier end and the suspension device is arranged, in particular centrally, between the carrier ends, wherein in a region of the carrier ends one of the running wheels of the running wheel pair is supported in a rotationally movable manner relative to the axle carrier. The longitudinal direction can correspond to an extent of the upper strand. The vertical direction can be orientated perpendicularly to the longitudinal direction. The vertical direction can extend counter to a gravitational force direction. A particularly great quiet running is produced for the track running gear when travelling over uneven underlying ground.

Preferably, two double axle arrangements are present and arranged in the longitudinal direction with spacing from each other. As a result, the quiet running of the track running gear is still further improved.

In another embodiment, at least one of the running wheels is constructed in an axially divided manner. In order to mount the rubber continuous track, which cannot be opened transversely relative to the circumferential direction thereof, the at least one running wheel can consequently be divided in order to pull up the rubber continuous track. After the rubber continuous track has been pulled up, the running wheel which is constructed in a divided manner can be assembled in order to construct the positive-locking lateral guide of the rubber continuous track.

With respect to the civilian tracked vehicle of the type mentioned in the introduction, same is particularly configured for use on a construction site and has a carrier frame and a track chassis which has at opposite sides of the carrier frame a track running gear according to the invention according to the preceding description. The above-mentioned advantages of the track running gear according to the invention are therefore also transferred mutatis mutandis to the civilian tracked vehicle according to the invention.

In another embodiment, a body structure is arranged on the carrier frame, wherein a driver's cab is arranged on the body structure or on the carrier frame in a manner offset relative to the body structure in a longitudinal vehicle direction, wherein the body structure is supported about at least one body rotation axis in a pivotable and/or rotatable manner relative to the carrier frame. The body structure can therefore be rotated and/or pivoted either relative to the driver's cab or together with the driver's cab. The body structure can comprise a tipper body and/or a body frame. Alternatively or additionally, the body structure can comprise at least one selected member from a box truck and/or a flatbed body and/or a tank.

Additional advantages and features of the invention will be appreciated from the claims and the following description of a preferred embodiment of the invention which is illustrated with reference to the drawings.

It will be understood that the above-mentioned features and the features still to be explained below can be used not only in the combination set out, but also in other combinations or alone without departing from the scope of the present invention.

### BRIEF DESCRIPTION OF THE DRAWINGS

FIG. 1 shows a schematic, perspective view of an embodiment of a civilian tracked vehicle according to the invention with an embodiment of a track running gear according to the invention, wherein a body structure of the civilian tracked vehicle is omitted for greater clarity;

FIG. 2 shows a schematic side view of the civilian tracked vehicle according to FIG. 1 with a body structure being shown;

FIG. 3 shows a detail of the illustration according to FIG. 2;

FIG. 4 shows a schematic plan view of a detail of the civilian tracked vehicle according to FIGS. 1 to 3, wherein a rubber continuous track is omitted for greater clarity;

FIG. 5 shows a detail of a schematic perspective view of the rubber continuous track for the civilian tracked vehicle according to FIGS. 1 to 4;

FIG. 6 shows a schematic, perspective view of a portion of the rubber continuous track according to FIG. 5;

FIG. 7 shows a schematic plan view of the portion according to FIG. 6;

FIG. 8 shows a schematic sectioned view of the rubber continuous track according to FIGS. 5 to 7;

FIG. 9 shows a schematic bottom view of the portion according to FIGS. 6 and 7; and

FIG. 10 shows an additional schematic sectioned view of the rubber continuous track according to FIGS. 5 to 9.

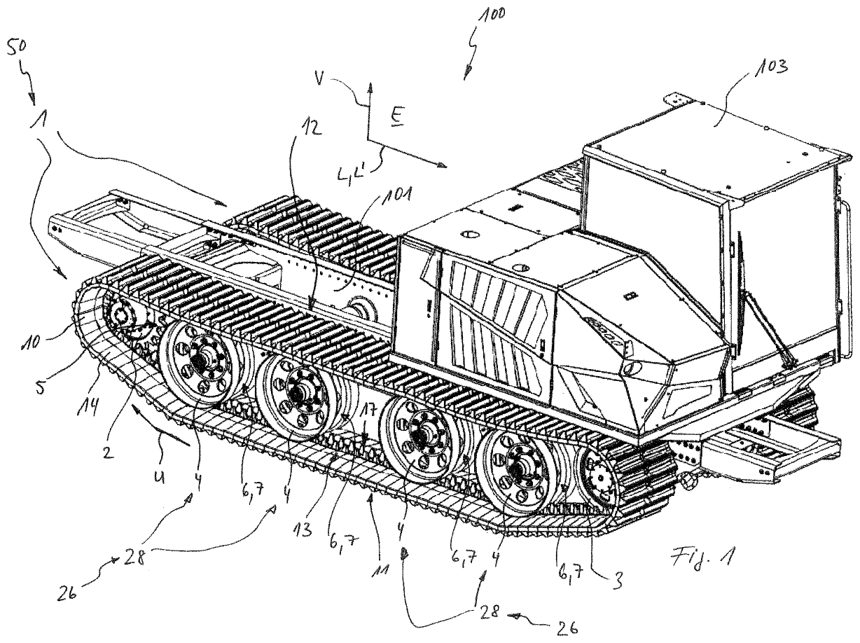

### DETAILED DESCRIPTION

A tracked vehicle 100 according to the invention can be used on a construction site. It has a carrier frame 101 and a track chassis 50. The track chassis 50 comprises two track running gears 1 according to the invention. One of the track running gears 1 is arranged at mutually opposite sides of the carrier frame 101.

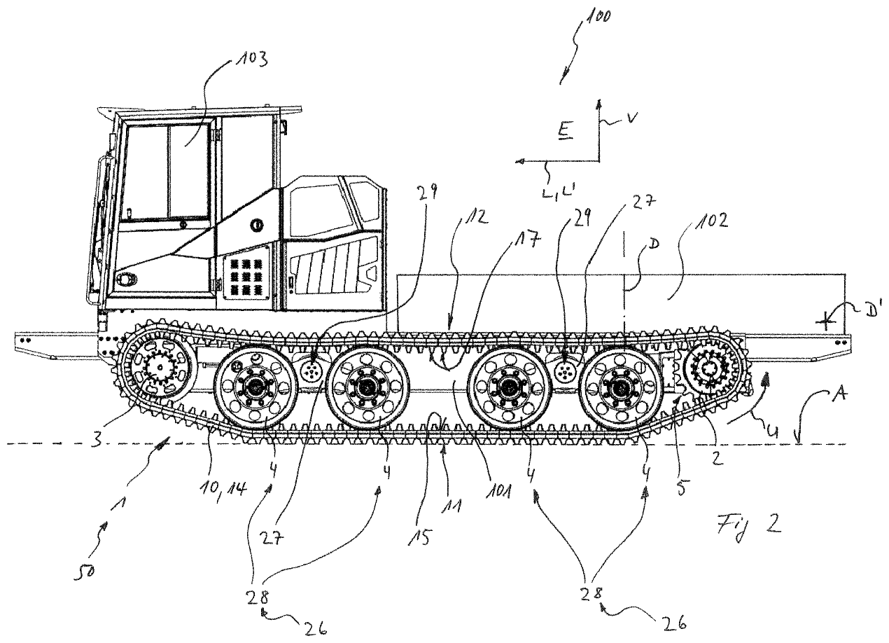

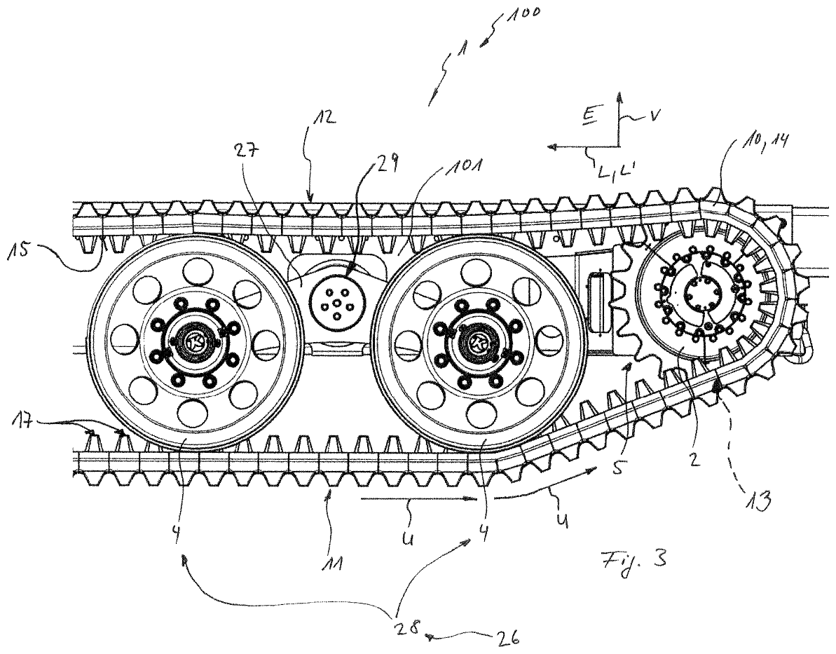

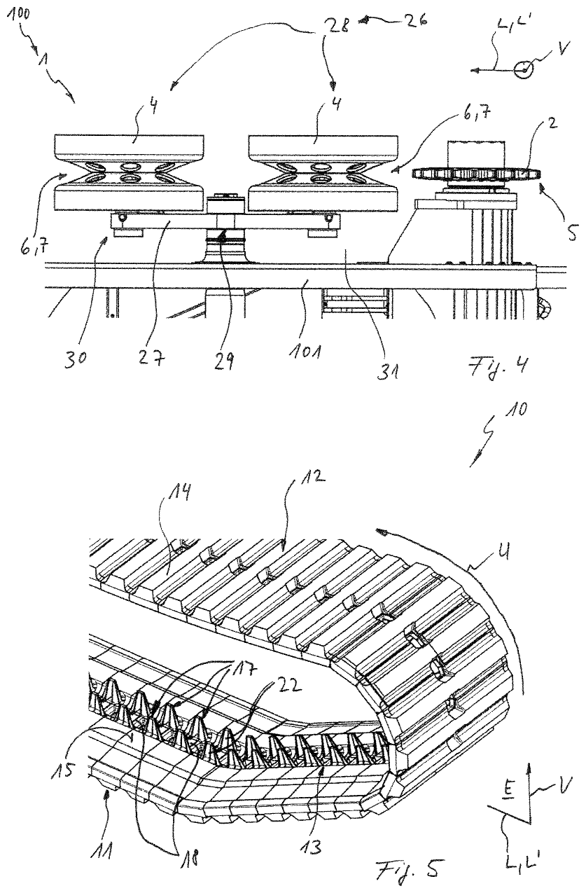

The track running gear 1 for the track chassis 50 of the civilian tracked vehicle 100 has a rubber continuous track 10. The rubber continuous track 10 comprises a rubber material. The rubber material may comprise a natural rubber and/or a synthetic rubber and/or another suitable elastomer material. The track running gear 1 comprises a drive wheel 2 which is arranged at the end and an opposite tension wheel 3. The rubber continuous track 10 is guided circumferentially over the end drive wheel 2, the opposite tension wheel 3 and over a plurality of running wheels 4. The drive wheel 2 and tension wheel 3 are opposite each other in a longitudinal direction L. By adjusting a spacing between the tension wheel 3 and the drive wheel 2, a track tension of the rubber continuous track 10 can be adjusted. The running wheels 4 are arranged in the longitudinal direction L between the drive wheel 2 and the tension wheel 3. In this instance, four running wheels 4 are present. Each of the running wheels 4 touches a lower strand 11 of the rubber continuous track 10. With the lower strand 11, the track running gear 1 can be in contact with an underlying ground A. The underlying ground A may be the ground and/or a carriageway. As a result of contact of the lower strand 11 with the underlying ground A, driving forces between the underlying ground A and the track running gear 1 can be transmitted. At least two of the running wheels 4 touch an upper strand 12, which is opposite the lower strand 11, of the rubber continuous track 10. The upper strand 12 is opposite the lower strand 11 in a vertical direction V. The vertical direction V can extend counter to a gravitational force direction. For example, at least two of the running wheels 4 touch the upper strand 12 if the track running gear 1 is located on even underlying ground A, cf. FIG. 2. In this case, all the running wheels 4 touch the upper strand 12. For example, all the running wheels 4 can touch the upper strand when the track running gear 1 is in the state located on even underlying ground A. In this case, the track running gear 1 is free from support rollers for guiding the upper strand 12 which are arranged with spacing from the lower strand 11. Alternatively to the embodiment shown, at least one of the running wheels 4 can be arranged with spacing from the upper strand 12. For example, the running wheel 4 which is nearest the drive wheel can be arranged with spacing from the upper strand.

The rubber continuous track 10 has an inner toothing 13 which extends at the internal circumference. The drive wheel 2 has an outer toothing 5 which extends at the external circumference. The outer toothing 5 meshes with the inner toothing 13 in order to drive the rubber continuous track 10 in a positive-locking manner. The inner and outer toothings 13, 5 are geometrically adapted to each other. For example, the inner toothing 13 and the outer toothing 5 have the same modulus. A tooth height of the outer toothing 5 can be adapted to the tooth height of the inner toothing 13. For example, the tooth heights of the inner toothing and the outer toothing 13, 5 can be of the same size or of different sizes. In this instance, the tooth height of the outer toothing 5 is greater than the tooth height of the inner toothing 13. It will be understood that the inner toothing 13 can also, in a transposed manner, have a greater tooth height than the outer toothing 5.

The rubber continuous track 10 has an annular base member 14. The base member 14 is constructed in a continuously circumferential manner in the circumferential direction U. This means that the base member 14 is free in the circumferential direction U from front ends which have to be connected to each other in order to close the annular shape thereof. The rubber continuous track 10 can be constructed to be free from chain joints. The annular base member 14 is constructed coherently without joints. The base member 14 is constructed without segments.

In this instance, the inner toothing 13 is constructed on an internal circumference 15 of the base member 14. The inner toothing 13 comprises a large number of intermediate tooth spaces 16. The intermediate tooth spaces 16 are arranged equidistantly relative to each other in the circumferential direction U.

The intermediate tooth spaces 16 step back from the internal circumference 15. At least one of the running wheels 4 —in this instance, each of the running wheels 4—has an external annular profiling 6. The annular profiling 6 can be provided on the respective running wheel 4 on the external circumference. The annular profiling 6 is provided to laterally guide the rubber continuous track 10 in a positive-locking manner.

The inner toothing 15 has in this instance a large number of track brackets 17. The track brackets 17 are arranged with spacing from each other in the circumferential direction U. They flank the tension wheel 3 and the drive wheel 2 at the external side or front side. In order to laterally guide the rubber continuous track 10, the track brackets 17 engage in an annular groove, which acts as an annular profiling, of the running wheels 4. In this instance, the annular profiling 6 of each of the running wheels 4 is constructed by such an annular groove 7. In the circumferential direction U, a tooth 18 of the inner toothing is constructed between every two adjacent intermediate tooth spaces 16 of the inner toothing 13. This tooth 18 is flanked by webs 22 of a track bracket 17. The longitudinal direction L and the vertical direction V define a vertical plane E. The vertical plane E therefore extends in the longitudinal direction L and the vertical direction V. The teeth 18 are in this case arranged perpendicularly to the vertical plane E between the webs 22. Therefore, two webs 22 which are arranged transversely to the circumferential direction U with spacing from each other are provided on each of the teeth 18. Two webs 22 which are arranged with spacing from each other perpendicularly to the vertical plane E are arranged, for example, on each of the teeth 18. Therefore, there are two rows, which extend parallel with each other in the circumferential direction U, of webs 22 provided in this case.

In this case, the intermediate tooth spaces 16 completely extend through the base member 14 in the vertical direction V. The intermediate tooth spaces 16 can extend through the base member 14 in the vertical plane E. The intermediate tooth spaces 16 can completely extend through the base member 14 radially. Since the tooth height of the outer toothing 5 is greater in this case than the tooth height of the inner toothing 15, the teeth of the outer toothing 5 can project partially outwardly through the intermediate tooth spaces 16. The intermediate tooth spaces 16 which extend through the base member 14 can be closed by means of a perforated or non-perforated membrane made of a material of the base member, which membrane can be passed through by the outer toothing 5 when the track running gear 1 is operated.

The base member 14 has in this case an elastomer matrix 19. The elastomer matrix 19 can include a rubber material or comprise a rubber material. The rubber material can comprise at least one rubber selected from natural rubber and/or synthetic rubber and/or another suitable elastomer material. The base member 14 further comprises a reinforcement device 20 for transmitting drive forces. The reinforcement device 20 is embedded in the elastomer matrix 19. In this instance, the reinforcement device 20 is completely embedded in the elastomer matrix 19. This means that the reinforcement device 20 is surrounded at all sides by the elastomer matrix 19. When the track running gear 1 is operated, the elastomer matrix 19 can be separated in regions so that the reinforcement device 20 is then surrounded only partially by the elastomer matrix 19.

The reinforcement device 20 comprises in this instance a large number of steel cords 21. The steel cords 21 extend in the circumferential direction U, for example, circumferentially. Alternatively or additionally, there may be provided a large number of additional steel cords 21 which extend at an angle relative to the circumferential direction U. For example, these steel cords 21 can extend between two mutually opposite flanks of the rubber continuous track 10. The reinforcement device 20 further comprises in this instance a planar fiber inlay 24. The planar fiber inlay 24 comprises reinforcement fibers. The reinforcement fibers can be selected from the group comprising glass fibers (that is to say, fibers having or comprising glass), basalt fibers (that is to say, fibers having or comprising basalt), boron fibers (that is to say, fibers having or comprising boron), ceramic fibers (that is to say, fibers having or comprising ceramic material), silicic acid fibers (that is to say, fibers having or comprising silicic acid), steel fibers (that is to say, fibers having or comprising steel), polyamide fibers (that is to say, fibers having or comprising polyamide), aramide fibers (that is to say, fibers having or comprising aramide), carbon fibers (that is to say, fibers having or comprising carbon), black diamond fibers (that is to say, fibers having or comprising black diamond), nylon fibers (that is to say, fibers having or comprising nylon), polyethylene fibers (that is to say, fibers having or comprising polyethylene), plexiglass fibers (that is to say, fibers having or comprising plexiglass) and admixtures of at least two of the above-mentioned fibers. The planar fiber inlay 24 may be a textile. The planar fiber inlay 24 may be a web and/or a woven fabric and/or a hosiery fabric and/or a knitted fabric and/or a nonwoven fabric, or a combination thereof.

The reinforcement device 20 further comprises in this case a large number of core members 25. The core members 25 may include a metal material or may comprise a metal material. The metal material may be a steel alloy. The core members 25 each extend transversely relative to the circumferential direction U. In this case, the core members 25 extend perpendicularly to the vertical plane E. The core members 25 are arranged in a mutually equidistant manner in the circumferential direction U in a manner alternating with the intermediate tooth spaces 16 of the inner toothing 15. Consequently, the core members 25 can form cores of the teeth 18. In this case, each tooth 18 has a core which is formed by one of the core members 25. The core members 25 can form cores of the track brackets 17, in particular the webs 22.

The track running gear 1 comprises a double axle arrangement 26. The double axle arrangement 26 has an axle carrier 27 and a running wheel pair 28 with two of the running wheels 4. The axle carrier 27 comprises a suspension device 29 for connecting the double axle arrangement 26 to a carrier frame 101 of the tracked vehicle 100 in a rotationally movable manner. The axle carrier 27 may, for example, be connected to the carrier frame 101 in a floating and/or oscillating manner by means of the suspension device 29 thereof. The two running wheels 4 of the running wheel pair 28 are supported in a rotationally movable manner on the axle carrier 27 with radial spacing from each other. The axle carrier 27 extends in the longitudinal direction L between a first and a second carrier end 30, 31. The suspension device 19 is, for example, arranged centrally between the carrier ends 30, 31. In this case, one of the running wheels 4 of the running wheel pair 28 is supported in a rotationally movable manner relative to the axle carrier 27 in a region of the carrier ends 30, 31. In this case, two such double axle arrangements 26 are provided per track running gear 1. The two double axle arrangements 26 of the track running gear 1 are arranged in this case with spacing from each other in the longitudinal direction L. The drive wheel 2 is arranged in the longitudinal direction L with spacing from the nearest running wheel 4. Alternatively, the drive wheel 2 and the running wheel 4 which is nearest it can intersect with each other in regions in the longitudinal direction L. The drive wheel 2 can then mesh with the annular groove 7 of the nearest running wheel 4. Such a meshing configuration, which is an alternative to the present embodiment, is not shown in the Figures.

For example, at least one of the running wheels 4 is constructed in an axially divided manner. In this case, each of the running wheels 4 is constructed in an axially divided manner. The drive wheel 2 can have at least two segments—in this instance, there are three such segments—which are connected to each other in a radially releasable manner.

In this case, the civilian tracked vehicle 100 has a body structure 102. The body structure 102 is arranged on the carrier frame 101. The body structure 102 can comprise a body frame. The body structure 102 can comprise a tipper body. The body structure 102 can comprise a box truck. The body structure 102 can comprise a flatbed. The body structure 102 can comprise a tank. In this case, the civilian tracked vehicle 100 comprises a driver's cab 103. The driver's cab 103 is arranged on the carrier frame 101 in this case in a manner offset in the longitudinal vehicle direction L′ relative to the body structure 102. Alternatively to the embodiment shown, the driver's cab 103 may be arranged on the body structure 102. The body structure 102 is supported relative to the carrier frame 101 in a pivotable and/or rotatable manner about at least one body rotation axis D, D′. In this case, the body structure 102 is supported relative to the carrier frame 101 in a rotatable manner about a first body rotation axis D and in a pivotable manner about a second body rotation axis D′. The first body rotation axis D extends in the vertical direction V. The second body rotation axis D′ extends in this case in the longitudinal vehicle direction L′. The longitudinal direction L of the track running gear 1 can correspond to the longitudinal vehicle direction L′.

In the embodiment shown, the body structure 102 is rotatable relative to the driver's cab 103. If the driver's cab 103 is arranged on the body structure 102—not shown in the Figures—the body structure can be rotated together with the driver's cab 103 relative to the carrier frame 101, in particular about the vertically orientated rotation axis D.

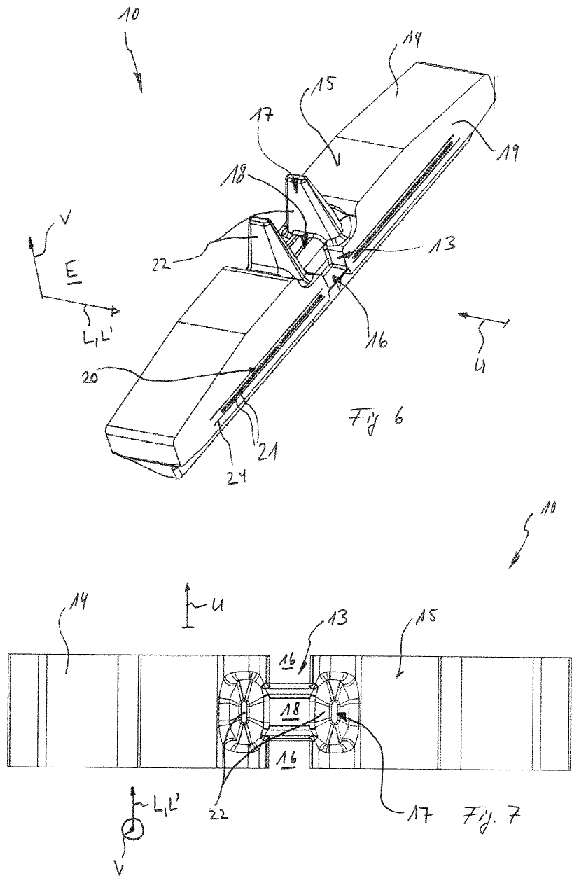

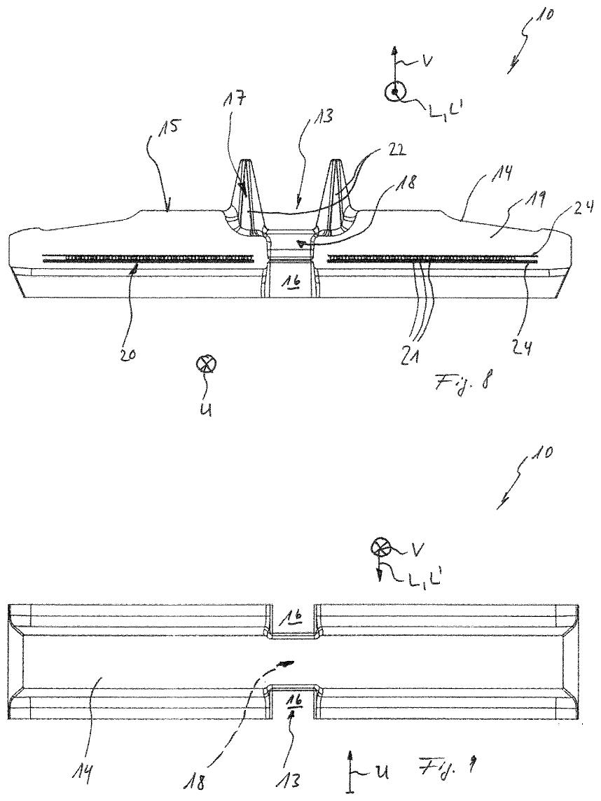

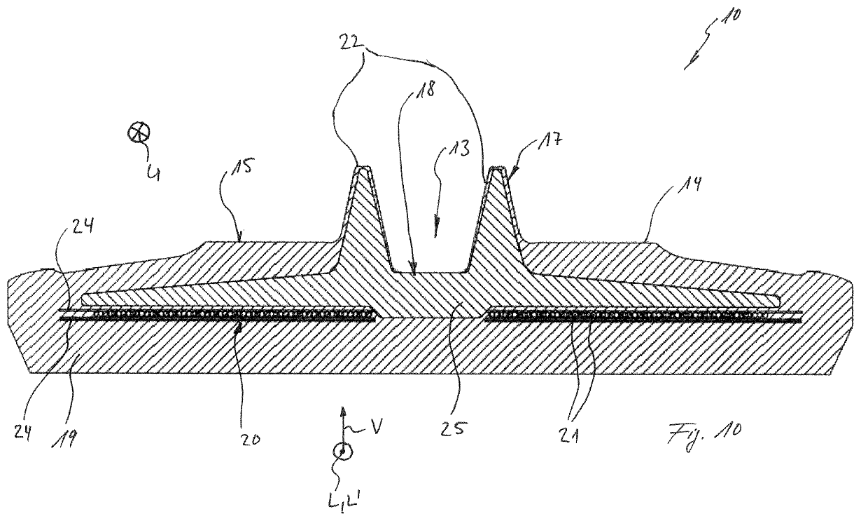

The rubber continuous track 10 comprises a large number of identical portions, of which each one corresponds to the portion shown in FIGS. 6, 7 and 9. The portions are formed integrally on each other in the circumferential direction. The portions are connected to each other in a materially integral manner.

1. A track running gear for a track chassis of a civilian tracked vehicle, comprising:
a rubber continuous track guided circumferentially over an end drive wheel, an opposite tension wheel and over a plurality of running wheels, wherein each of the running wheels touches a lower strand of the rubber continuous track; and
at least two of the running wheels, in particular at least in a state located on even underlying ground, of the track running gear, touch an upper strand, located opposite the lower strand, of the rubber continuous track.

2. The track running gear according to claim 1, wherein at least one of the running wheels has an external annular profiling provided to laterally guide the rubber continuous track in a positive-locking manner.

3. The track running gear according to claim 1, wherein an inner toothing of the rubber continuous track has a large number of track brackets arranged with spacing from each other in a circumferential direction, the track brackets externally flanking the tension wheel and the drive wheel and engaging in an annular groove, the annular groove acting as an annular profiling, of the running wheels for laterally guiding the rubber continuous track.

4. The track running gear according to claim 3, wherein a tooth of the inner toothing is constructed in the circumferential direction between two adjacent intermediate tooth spaces of the inner toothing, the tooth being flanked by webs of a track bracket, respectively.

5. The track running gear according to claim 4, wherein the intermediate tooth spaces completely extend through a base member of the rubber continuous track in a vertical direction.

6. The track running gear according to claim 5, wherein the base member comprises an elastomer matrix, in particular made from a rubber material.

7. The track running gear according to claim 6, wherein, in order to transmit drive forces, the base member comprises a reinforcement device embedded in the elastomer matrix, in particular completely.

8. The track running gear according to claim 7, wherein the reinforcement device comprises a large number of core members, in particular made of steel, each core member extending transversely relative to the circumferential direction.

9. The track running gear according to claim 8, wherein the core members are arranged equidistantly to each other in the circumferential direction in an alternating manner with the intermediate tooth spaces of the inner toothing.

10. The track running gear according to claim 1, wherein the track running gear further includes at least one double axle arrangement, the double axle arrangement comprising an axle carrier and a running wheel pair with two of the running wheels, wherein the axle carrier has a suspension device for connecting the double axle arrangement to a carrier frame of the tracked vehicle in a rotationally movable manner, and wherein the two running wheels of the running wheel pair are supported in a rotationally movable manner on the axle carrier with radial spacing from each other.

11. The track running gear according to claim 10, wherein the axle carrier extends in a longitudinal direction of the track running gear between a first carrier end and a second carrier end and the suspension device is arranged, in particular centrally, between the carrier ends, wherein in a region of the carrier ends one of the running wheels of the running wheel pair is supported in a rotationally movable manner relative to the axle carrier.

12. The track running gear according to claim 1, wherein at least one of the running wheels is constructed in an axially divided manner.

13. A civilian tracked vehicle, in particular for use on a construction site, comprising:
a carrier frame; and
a track chassis having a track running gear at opposite sides of the carrier frame, the track running gear comprising a rubber continuous track guided circumferentially over an end drive wheel, an opposite tension wheel and over a plurality of running wheels, wherein each of the running wheels touches a lower strand of the rubber continuous track, and at least two of the running wheels, in particular at least in a state located on even underlying ground, of the track running gear, touch an upper strand, located opposite the lower strand, of the rubber continuous track.

14. The civilian tracked vehicle according to claim 13, wherein a body structure is arranged on the carrier frame, a driver's cab is arranged on the body structure or on the carrier frame in a manner offset relative to the body structure in a longitudinal vehicle direction, and the body structure is supported about at least one body rotation axis in a pivotable and/or rotatable manner relative to the carrier frame.
